(19) United States
(12) Patent Application Publication
(10) Pub. No.: US 2009/0047392 A1
(43) Pub. Date: Feb. 19, 2009

(54) Methods for Producing Sterol-Containing Compositions

(75) Inventors: Peter Horlacher, Bellenberg (DE); Bernd Jenzer, Balzheim (DE); Alois Hofmann, Illertissen (DE); Jurgen Gierke, Illertissen/Betlinshausen (DE); Katja Beck, Bellenberg (DE)

Correspondence Address: FOX ROTHSCHILD LLP, 1101 MARKET STREET, PHILADELPHIA, PA, 19107, US

(73) Assignee: Cognis IP Management GmbH, Duesseldorf (DE)

(21) Appl. No.: 12/282,169

(22) PCT Filed: Dec. 4, 2006
(86) PCT No.: PCT/EP2006/011602

§ 371 Date: Sep. 8, 2008

(30) Foreign Application Priority Data
Mar. 8, 2006 (DE) 10 2006 010 663.6

(51) Int. Cl. A23L 1/48; A23P 1/08; A23L 2/52; A23C 9/152

(52) U.S. Cl. 426/96; 426/290; 426/590; 426/580

(57) ABSTRACT

The invention relates to a method for producing coated sterol powder, wherein a) a carbohydrate and/or a protein and/or a protein-containing auxiliary agent is dissolved or dispersed in water or in an aqueous suspension medium, b) said sterol and/or stanol particles are added to the solution/dispersion, c) the thus obtained solution is homogenised in a homogeniser or a colloid mill in the circuit, d) one part of the homogenate is extracted in a continuous manner from the circuit and directly e) introduced into a dry-spraying system by pulverisation and spraying. The coated sterol-containing particles produced according to said method are incorporated into food based due to their good wettability and without using complex equipment, and display, in particular, good organoleptic and sensory properties in drinks.

### CROSS-REFERENCE TO RELATED APPLICATIONS

This application is the National Phase entry of PCT/EP2006/011602, filed Dec. 4, 2006, which claims priority to German patent application number DE 102006010663.6, filed Mar. 8, 2006, each of which are incorporated herein by reference in their entireties.

### FIELD OF THE INVENTION

This invention relates generally to processes for the production of phytosterol-containing compositions, preferably powders, and to the compositions produced by such processes and to preparations, more especially foods, containing these formulations.

### BACKGROUND OF THE INVENTION

The literature offers numerous formulation options for enabling poorly soluble phytosterols and phytostanols, which are known to lower cholesterol, to be incorporated in food preparations, cosmetic or pharmaceutical products. Besides leading to poor dispersibility, the unfavorable solubility behavior of the substances reduces their bioavailability and adversely affects the stability of the food preparations.

Numerous patent applications describe how the availability of sterols can be improved by reducing the particle sizes, mainly by micronization. Thus, DE 102 53 111 A1 describes powder-form phytosterol formulations with a mean particle size of 0.01 to 100 μm which can readily be redispersed in water. Hydrophilic auxiliaries are preferably used as protective colloids. Organic solvents are used in the production of the powders to the detriment of ecology and compatibility.

Another process for the production of a sterol dispersion, in which the sterols have a particle size distribution of 0.1 to 30 μm, is described in International patent application WO 03/105611 A2. As in this process, the micronization of the sterol particles is often not sufficient on its own to facilitate uniform incorporation. Although the bioavailability of the finely dispersed particles can be increased by enlarging the surface area, the wettability of the micronized particles is so poor that they readily aggregate and generally float on water-containing surfaces. In many cases, the ground sterol can only be dispersed in a beverage by special methods which involve intensive mixing. However, corresponding mixers are not normally available to the end user, the food manufacturer.

Accordingly, many manufacturers combine the micronization of the sterols with the additional use of emulsifiers. One example of this is represented by the preparations claimed in European patent EP 0897671 B1 which contain sterols and sterol esters with a particle size of at most 15 μm in the form of a mixture with selected emulsifiers, the ratio by weight of emulsifier to sterol in the aqueous phase being less than 1:2.

International patent application WO 03/086468 A1 describes powder-form sterol ester formulations having a low protein content and containing mono- and diglycerides as emulsifiers. Even though these formulations are distinguished by good compatibility and have already been known for some time as food emulsifiers, efforts are being made to reduce the quantity of emulsifiers or even to avoid them altogether because emulsifiers can also influence the bioavailability of other substances present in the foods or can adversely affect the stability of the formulations.

Many other methods for improving solubility and dispersibility, such as formulation as emulsions, microemulsions, dispersions, suspensions or complexing with cyclodextrins or bile salts, are mentioned in International patent application WO 99163841 A1, including formulation in the form of preparations. PEG, PVP, copolymers, cellulose ethers and esters are proposed as carriers. The direct use of food bases as carriers for powder-form sterols in the form of a premix is also known, see EP 1 003 388 B1. The choice of proteins as carriers for unesterified sterols and stanols is disclosed in WO 01/37681.

The processing of unesterified sterols and stanols, which are far more hydrophobic than their esterified derivatives, imposes particularly stringent demands on the production process. One possible process for the production of sterol-containing microparticles is described in European patent EP 1148793 B1. It is based on high-energy homogenization. However, a powder subsequently produced on the basis of water-containing suspension media shows unsatisfactory homogeneity and is difficult to redisperse.

One object of certain aspects of the present invention is to provide compositions free from one or more of the disadvantages mentioned at the beginning, and/or which would enable unesterified sterols and/or stanols to be more easily and uniformly dispersed in foods, and/or which would provide the foods with favorable sensory and organoleptic properties.

### DETAILED DESCRIPTION OF THE EMBODIMENTS

The present invention relates in preferred embodiments to processes for the production of coated sterol-containing powders in which
a) a carbohydrate and/or a protein and/or a protein-containing auxiliary is dissolved and/or dispersed in water and/or in a water-containing suspension medium,
b) sterol and/or stanol particles are added to the resulting solution/dispersion,
c) the suspension thus form is homogenized, preferably by circulation through a slot homogenizer or a colloid mill,
d) at least part of the homogenizate is removed from the circuit, preferably continuously, and
e) is introduced, preferably by being directly delivered, to a spray dryer and spray-dried.

It is possible according to preferred processes according to the invention to produce powders even containing free unesterified sterols and stanols which enable the lipophilic active components to be more readily further processed in foods, more especially beverages. The preferred powders exhibit little tendency to agglomerate and, hence, have good flow properties. The preferred powders are distinguished by good homogeneity and, by virtue of their improved wettability, can be in many cases, further processed without major investment in equipment. In addition, the preferred powders can be uniformly distributed very quickly in the final formulation. The preferred coating greatly improves the organoleptic properties and the sensory impression. The coated powder does not stick to teeth or oral mucous membranes, so that the unpleasant sterol taste, which leads to serious losses of taste in foods containing the active components, is substantially suppressed in preferred embodiments.

In accordance with preferred aspects, coating the present powder compositions with hydrophilic auxiliaries, such as carbohydrates, proteins or protein-containing additives, not only improves solubilization properties and dispersion properties, the powders surprisingly also show increased storage stability in relation to ground sterols which have a strong tendency to agglomerate.

When it comes to the processing of unesterified sterols and stanols in the aqueous medium, the preferred processes reduce, and preferably eliminate, the need to use highly surface-active emulsifiers, such as lecithins, monoglycerides, diglycerides, polysorbates, sodium stearyl lactylate, glycerol monostearate, lactic acid esters and polyglycerol esters. The minimal emulsifier properties of the auxiliaries that impart hydrophilicity, more particularly the proteins, caseinates and protein-rich auxiliaries, are in many embodiments sufficient to enhance the homogeneity of the powder produced and to improve redispersibility and processability. The absence of other emulsifiers simplifies further processing by reducing possible incompatibilities with other food ingredients and reduces the occurrence of incompatibilities at the end user. The need for highly active emulsifiers, such as lecithins, monoglycerides, diglycerides, polysorbates, sodium stearyl lactylate, glycerol monostearate, lactic acid esters and polyglycerol esters, can be greatly reduces in many embodiments by use of the preferred continuous homogenization and direct removal and delivery of the homogenized suspension to the spray dryer. Such preferred processes according to the invention enable powders having a very high sterol content and the favorable properties described above to be produced without any need whatever to use organic solvents. The coated sterol formulations preferably contain at least about 50% by weight, more preferably at least about 55% by weight and most preferably at least about 65% by weight sterols, including sterol derivatives, such as stanols, based on the weight of the powder.

The sterol-containing formulations produced by the present processes may readily be incorporated in foods, more particularly in milk, milk beverages, whey and yogurt beverages, margarine, fruit juices, fruit juice mixtures, fruit juice beverages, vegetable beverages, still and sparkling beverages, soya milk beverages and protein-rich liquid food substitute beverages and fermented milk preparations, yogurt, drinking yogurt, or cheese preparations, cereals and nutrition bars, and also in cosmetic or pharmaceutical preparations.

In the first step of the preferred production process, in which a carbohydrate and/or a protein and/or a protein-containing auxiliary is dissolved or dispersed in water or a water-containing suspension medium, the hydrophilic auxiliaries serving as subsequent coating materials are dissolved or dispersed. To this end, the water or the water-containing suspension medium is preferably heated to a temperature of about 50° C. to about 80° C., and more preferably to a temperature of about 65 to about 75° C. In this first step, the other auxiliaries are also preferably added as required to the aqueous phase or to the water-containing suspension medium.

In a preferred embodiment, glucose and casein or caseinates are used as auxiliaries. It has proved to be particularly effective in certain embodimentsto use casein (acid casein) which is only converted into sodium caseinate after dispersion in heated water by the addition of sodium hydroxide to a pH of about 6.5 to about 7.5 in the dispersion medium. Surprisingly, the process with this in situ formation of sodium caseinate results in a better dispersible end formulation by comparison with a process in which sodium caseinate is directly added.

In another preferred embodiment, glucose and milk powder are used as auxiliaries. It has proved to be particularly effective to use skim milk powder because this auxiliary is the best at masking the typical unpleasant sterol taste and formulations containing skim milk powder have improved sensory properties in relation to other auxiliaries.

Instead of and/or in addition to pure water, it is also possible to use water-containing suspension media which form the basis of the sterol-containing food to be subsequently produced. Thus, beverages such as, for example, milk, milk beverages, whey and yogurt beverages, fruit juices, fruit juice mixtures, fruit juice beverages, vegetable beverages, soya milk beverages and protein-rich liquid food substitute beverages and fermented milk preparations, but preferably fruit and vegetable beverages, may be directly used as the suspension medium in step a). The sterol-containing powder obtained after spray drying may then readily be redispersed with water to give a sterol-containing beverage ready for drinking.

This solution or dispersion of the hydrophilic auxiliaries is preferably heated to about 75° C. to about 95° C. and preferably to about 80° C. to about 85° C., and sterol and/or stanol particles are preferably added to the system with stirring. It has proved to be particularly effective to use ground sterols and/or stanols having a small particle size with a D_{90%} of at most about 50 μm (as measured with a Beckman Coulter LS 320 laser diffractometer, expressed as volume distribution). The measurement is conducted in a suspension containing 10% Lamegin ZE 609 (Citrem®) in the process. The addition of larger particles in turn leads to end formulations with larger particle sizes which reduce bioavailability and are therefore undesirable in many embodiments. Sterols and/or stanols having a particle size distribution with a D_{90%} of at most about 30 μm are preferably used.

The suspension thus formed is then homogenized by circulation through a slot homogenizer or a colloid mill. The Fryma mill used is based on the rotor-stator principle. The homogenization of the sterol-containing suspension merely leads to size reduction of the agglomerates, the sterol particles themselves undergoing no further size reduction during the treatment. Where skim milk powder is used as the auxiliary to impart hydrophilicity, homogenization with the colloid mill is sufficient to guarantee uniform distribution of the sterol particles before introduction into the spray drying tower.

At least a portion of the homogenizate is preferably continuously removed from the volume stream and delivered to the spray drying tower. Without the addition of highly surface-active emulsifiers, it is difficult to maintain the strongly lipophilic unesterified sterol and stanol particles with sufficient homogeneity in the suspension medium. The suspension thus homogenized generally does not have good physical stability. Accordingly, it is highly preferred for at least a portion, and in certain embodiments only a portion, of the suspension homogenized in the slot homogenizer to be directly and continuously removed and delivered to the spray drying tower.

The actual coating of the particles preferably takes place through the immediate spray drying in the spray drying tower. Because the particles are spray dried from a water-containing medium, the hydrophilic auxiliaries remain on the surface of the lipophilic sterol particles after evaporation of the water and form a hydrophilic coating which significantly improves the properties of the powder formed. Besides their lipophilic properties, generally the ground sterol particles used in the process have uneven surfaces which easily become entangled with one another. The hydrophilic coating preferably provides substantially round particles which have much better flow properties and hence better processability.

By virtue of the evaporation coldness of the water during spray drying, the suspended sterol or stanol particles do not melt, even at high feed air temperatures. The particles thus comprise a core which contains the original sterol or stanol particle and a coating of the hydrophilic auxiliaries.

It is expected and understood that those skilled in the art will be able to readily adapt the spray drying conditions to the particular formulation by routine variations. In the preferred embodiment of the process, in which glucose and casein or caseinate are used as hydrophilic auxiliaries in a quantity of from about 40% to about 80% by weight sterols and/or stanols, from about 3% to about 30% by weight glucose and from about 10% to about 30% by weight casein and/or caseinate, based on the formulation as a whole, good results have been obtained with a feed air temperature of from about 170° C. to about 190° C., a waste air temperature of 90±15° C. and an atomizer speed of from about 20,000 to about 30,000 r.p.m.

Sterol and/or Stanol

Sterols obtained from plants and vegetable raw materials—so-called phytosterols and phytostanols—are used in the present invention. Known examples are ergosterol, brassica sterol, campesterol, avenasterol, desmosterol, clionasterol, stigmasterol, poriferasterol, chalinosterol, sitosterol and mixtures thereof. Of these, β-sitosterol and campesterol are preferably used. Hydrogenated saturated forms of the sterols, known as stanols, are also included among the compounds used. Again, β-sitostanol and campestanol are preferred. Vegetable raw material sources include inter alia seeds and oils of soybeans, canola, palm kernels, corn, coconut, rape, sugar cane, sunflower, olive, cotton, soya, peanut or products from the production of tall oil.

The preparations according to the invention contain from about 10% to about 90% by weight, preferably from about 30% to about 70% by weight and, in a particularly preferred embodiment, from about 35% to about 65% by weight sterols and/or stanols, based on the powder-form coated preparations.

The present invention also relates in certain aspects to food preparations containing sterol/stanol formulations with the composition mentioned above. They are preferably used in beverages and milk products which then contain from about 0.1% to about 50% by weight and preferably from about 1% to about 20% by weight of the powder-form coated preparations, based on the total weight of the food.

Protein-Containing Auxiliaries and/or Proteins

The protein-containing auxiliaries preferably used are milk powders, such as commercially available whole milk and skim milk powders, which have been obtained from corresponding types of milk by drying. They may be used in the form of mixtures with other proteins or as sole carrier. If other proteins are added or if proteins instead of milk powder are used as the carrier, these proteins are understood to be isolated proteins which are obtained from natural animal and vegetable sources and which are added in the production of the powder-form preparations. Possible sources of proteins are plants, such as wheat, soya, lupins, corn or sources of animal origin, such as eggs or milk.

Milk powders or milk-derived proteins, such as casein and casein salts, sodium and/or calcium caseinates are preferably used. Skim milk powder and/or casein and caseinates are particularly preferred for the purposes of the invention because, on the one hand, they have emulsifying properties without, at the same time, showing the disadvantages mentioned at the beginning of the food emulsifiers otherwise normally used specifically for the production of beverages and milk products, more particularly fermentation products, such as yogurt.

The preparations according to the invention preferably contain from about 5% to about 90% by weight, preferably from about 5% to about 70% by weight, more preferably from about 10% to about 40% by weight and most preferably from about 12% to about 35% by weight milk powder and/or proteins, preferably in the form of skim milk powder or casein and/or sodium caseinate and/or calcium caseinate, based on the coated powder-form preparation.

### Carbohydrates

The compounds used as carbohydrates preferably all contain food-compatible sugars selected from the group consisting of glucose, sucrose, fructose, trehalose, maltose, maltodextrin, cyclodextrin, invert sugar, palatinose and lactose. Glucose in the form of glucose syrup is preferably used as the carbohydrate. With the dispersibility and stability of the preparation in mind, it has proved to be particularly effective to use from about 0% to about 40% by weight, preferably from about 10% to about 35% by weight and, in a particularly preferred embodiment, from about 15% to about 30% by weight carbohydrates, based on the weight of powder-form sterol/stanol formulation.

### Other Auxiliaries

The preparations according to preferred aspects of the invention contain antioxidants, preservatives and flow promoters as further auxiliaries. Examples of possible antioxidants or preservatives are tocopherols, lecithins, ascorbic acid, parabens, butyl hydroxytoluene or anisole, sorbic acid or benzoic acid and salts thereof. Tocopherols are preferably used as antioxidants. Silicon dioxide may be used as a flow regulator and promoter.

### Powder-Form Coated Sterol Preparations

From their production, the preferred powder-form coated sterol formulations have a lipophilic core of sterols and/or stanols, optionally with other lipophilic auxiliaries, which is covered with a coating of hydrophilic auxiliaries. They preferably comprise
a) from about 10% to about 97% by weight unesterified sterols and/or stanols,
b) from about 3% to about 70% by weight sodium and/or calcium caseinate and/or milk powder,
c) from about 0% to about 40% by weight carbohydrates,
   preferably
a) from about 10% to about 90% by weight unesterified sterols and/or stanols,
b) from about 5% to about 70% by weight sodium and/or calcium caseinate and/or milk powder,
c) from about 0% to about 40% by weight carbohydrates
   and
(a) from about 30% to about 70% by weight unesterified sterols and/or stanols,
(b) from about 10% to about 40% by weight sodium and/or calcium caseinate and/or milk powder,
(c) from about 10% to about 35% by weight glucose,

In particularly preferred embodiments, the compositions comprise
(a) from about 35% to about 65% by weight unesterified sterols and/or stanols,
(b) from about 12% to about 35% by weight sodium and/or calcium caseinate,
(c) from about 10% to about 35% by weight glucose,
   and, more especially,
(a) from about 50% to about 65% by weight unesterified sterols and/or stanols,
(b) from about 12% to about 35% by weight sodium and/or calcium caseinate and/or skim milk powder,
(c) from about 15% to about 30% by weight glucose,
   or
(a) from about 65% to about 75% by weight unesterified sterols and/or stanols,
(b) from about 25% to about 35% by weight skim milk powder,
   or
(a) from about 90% to about 97% by weight unesterified sterols and/or stanols,
(b) from about 3% to about 10% by weight skim milk powder
   based on the total weight of the powder, provided that they are substantially free from highly surface-active emulsifiers selected from the group consisting of lecithins, monoglycerides, diglycerides, polysorbates, sodium stearyl lactylate, glycerol monostearate, lactic acid esters and polyglycerol esters.

### EXAMPLES

### Example 1

129.2 g casein (from Meggle, Nährcasein 30/60 mesh) were added to 1160 g cold water and heated to ca. 72° C. During this heating phase, the pH was adjusted to 7.0 by addition of NaOH. 132.5 g glucose syrup were then added, followed by heating to 80-85° C. The ground sterol (250 g Vegapure® FTE) having a particle size distribution with a D_{90%} of at most 30 μm (laser diffractometry, Beckman Coulter LS 320) was then added in portions. The suspension was passed through a Fryma mill (from Fryma Rheinfelden, type MZ 80 R, slot width: 240 μm) and then homogenized by circulation through an APV homogenizer (220/30 bar). Ca. 30% of the product stream was then fed continuously from the circuit to a spray dryer (APV Anhydro, type 3 S) and spray dried. The remaining suspension was kept circulating and gradually fed to the spray drying tower.

### Spray Drying Conditions:

inlet air temperature: 180±5° C.
outlet air temperature: 90±5° C.
atomizer speed: 24,000 r.p.m.

The particle size distribution of the powder was then measured by laser diffractometry (Beckman Coulter LS 320): D_{50%} 5 μm, D_{90%} 29 μm.

### Example 2

150 g skim milk powder (spray-dried skim milk powder, ADPI grade, supplier: Almil Bad Homburg) were added to water (1280 g) and heated to ca. 80° C. The ground sterol (350 g Vegapure FTE) was then added in portions. The suspension was repeatedly circulated through a Fryma mill (slot width: 240 μm). Ca. 30% of the product stream was then fed continuously from the circuit to a spray dryer (APV Anhydro, type 3 S) and spray dried. The remaining suspension was kept circulating and gradually fed to the spray drying tower.

### Spray Drying Conditions:

inlet air temperature: 185±5° C.
outlet air temperature: 90±5° C.
atomizer speed: 24,000 r.p.m.

### Example 3

15 g skim milk powder (spray-dried skim milk powder, ADPI grade, supplier: Almil Bad Homburg) were added to water (1000 g) and heated to ca. 80° C. The ground sterol (485 g Vegapure FTE) was then added in portions. The suspension was repeatedly circulated through a Fryma mill (slot width: 240 μm). Ca. 30% of the product stream was then fed continuously from the circuit to a spray dryer (APV Anhydro, type 3 S) and spray dried. The remaining suspension was kept circulating and gradually fed to the spray drying tower.

### Spray Drying Conditions:

inlet air temperature: 185±5° C.
outlet air temperature: 90±5° C.
atomizer speed: 24,000 r.p.m.

### Dispersion Test

The powders thus obtained were dispersed in milk and water in comparison with ground sterols comparable in their particle size distribution. To this end, ca. 250 ml of the liquid to be tested were poured into a glass beaker and stirred (ca. 100 r.p.m.). 2.5 g of the powders respectively containing 50% by weight and 70% by weight sterol were added to the stirred liquid and evaluated for dispersion behavior.

The encapsulated sterol could be very uniformly dispersed in cold water (15° C.) and hot water (60° C.) and in milk (18° C.) whereas the untreated sterol was poorly dispersed and, owing to the hydrophobic surface, remained on the liquid surface. Even a preparation containing only 3% milk powder could be dispersed far more uniformly than the pure sterol powder.

Sensory evaluation showed that the encapsulated sterols tasted neutral in water and did not stick to the gums or mouth whereas the untreated powder stuck to the oral mucous membrane and, besides a typical negative sterol taste, left behind an unpleasant sensory impression. Whereas the casein-containing powder could be dispersed somewhat better than the powder containing skim milk, the latter showed improved taste properties in relation to the casein-containing powder.

1-10. (canceled)

11. A process for the production of coated sterol powders, comprising:
a) dissolving or dispersing a carbohydrate and/or a protein and/or a protein-containing auxiliary in water or an aqueous suspension medium to form a coating solution/dispersion,
b) adding sterol and/or stanol particles to said solution/dispersion to form a suspension,
c) homogenizing said suspension by circulating through a slot homogenizer and/or a colloid mill,
d) continuously removing a portion of said homogenate from circulation, and
e) spray-drying said continuously removed portion by directly feeding to a spray dryer.

12. The process of claim 11, wherein said protein or protein-containing auxiliary is selected from the group consisting of milk powder, casein, caseinates and mixtures thereof.

13. The process of claim 11, wherein said carbohydrate is selected from the group consisting of glucose, sucrose, fructose, trehalose, maltose, maltodextrin, cyclodextrin, invert sugar, palatinose and lactose.

14. The process of claim 11, wherein said auxiliary is selected from the group consisting of glucose, casein, sodium caseinate, calcium caseinate, skim milk powder and mixtures thereof.

15. The process of claim 11, wherein said sterol and/or stanol particles have a particle size distribution with a D_{90%} of at most 50 μm.

16. The process of claim 11, wherein said aqueous suspension medium is a beverage.

17. The process of claim 16, wherein said beverage is selected from the group consisting of fruit juice and vegetable juice.

18. A powder-form coated sterol preparation obtained by the process of claim 11.

19. A food preparation comprising about 0.1 to about 50% by weight of the powder-form coated sterol preparation of claim 18.

20. A beverage or milk product comprising about 0.1 to about 50% by weight of the powder-form coated sterol preparation of claim 18.

21. A powder-form coated sterol preparation comprising a core of sterols and/or stanols and a coating of hydrophilic auxiliaries, comprising
a) about 10 to about 97% by weight of unesterified sterols and/or stanols,
b) about 3 to about 70% by weight of sodium and/or calcium caseinate and/or milk powder,
c) about 0 to about 40% by weight of carbohydrates,
based on the powder-form coated sterol preparation, provided that said preparation does not contain highly surface-active emulsifiers selected from the group consisting of lecithins, monoglycerides, diglycerides, polysorbates, sodium stearyl lactylate, glycerol monostearate, lactic acid esters and polyglycerol esters.
